(19) United States
(12) Patent Application Publication
(10) Pub. No.: US 2026/0197207 A1
(43) Pub. Date: Jul. 9, 2026

(54) MANAGING SIGNAL TRANSMISSIONS USING COMMUNICATION CABLES WITH INTEGRATED DRIVERS

(71) Applicant: Aivres Systems Inc., San Jose, CA (US)

(72) Inventor: Sheng sung CHIU, New Taipei City (TW)

(21) Appl. No.: 19/011,117

(22) Filed: Jan. 6, 2025

(51) Int. Cl. G06F 1/18; H05K 1/14; H05K 1/18

(52) U.S. Cl. CPC H04L 25/026

(57) ABSTRACT

Methods, devices, subsystems, systems, and techniques for managing signal transmissions using communication cables with integrated drivers are provided. In one aspect, a computing system includes: a first device integrated on a first circuit board, a first connector integrated on the first circuit board and coupled to the first device, a second device integrated on a second circuit board, a second connector integrated on the second circuit board and coupled to the second device, and a communication cable coupled between the first connector and the second connector and configured to transfer a signal between the first device and the second device. The communication cable includes a driver integrated in the communication cable and configured to drive the signal transferred by the communication cable between the first device and the second device.

### TECHNICAL FIELDS

The present disclosure is related to signal transmissions using communication cables.

### BACKGROUND

Computing devices, such as servers, are widely used in a variety of fields. In areas such as artificial intelligence (AI) and big data, the need for computing is growing rapidly. To improve flexibility and computational efficiencies, some computing devices are configured to include different external devices within the same server chassis, making the computing devices suitable for a variety of applications. Communication cables can be used to connect different components in the computing devices.

### SUMMARY

The present disclosure describes methods, devices, systems and techniques for managing signal transmissions using communication cables with integrated drivers, e.g., communication cables integrated with driver circuits for Serial Advanced Technology Attachment (SATA) or Peripheral Component Interconnect Express (PCIe) data transmissions between processors and storage devices, or Ultra Path Interconnect (UPI) data transmissions between multiple processors.

One aspect of the present disclosure features a computing system, including: a first device integrated on a first circuit board; a first connector integrated on the first circuit board and coupled to the first device; a second device integrated on a second circuit board; a second connector integrated on the second circuit board and coupled to the second device; and a communication cable coupled between the first connector and the second connector and configured to transfer a signal between the first device and the second device. The communication cable includes a driver integrated in the communication cable and configured to drive the signal transferred by the communication cable between the first device and the second device.

In some implementations, the driver includes: a driver circuit board; and at least one driver circuit integrated on the driver circuit board, where the at least one driver circuit is configured to drive the signal.

In some implementations, the communication cable includes a plurality of first electrical wires coupled to the first connector and a plurality of second electrical wires coupled to the second connector. The driver circuit board includes one or more first connection pins coupled to one or more first electrical wires and one or more second connection pins coupled to one or more second electrical wires, the one or more first connection pins and the one or more second connection pins being on a peripheral area of the driver circuit board. Each of the at least one driver circuit includes one or more first nodes coupled to the one or more first connection pins and one or more second nodes coupled to the one or more second connection pins.

In some implementations, the communication cable is configured to transfer the signal between the first device and the second device through a plurality of signal paths. Each of the plurality of signal paths is associated with a corresponding first electrical wire, a corresponding first connection pin, a corresponding first node, a corresponding second node, a corresponding second connection pin, and a corresponding second electrical wire.

In some implementations, along each of the plurality of signal paths, the driver further includes at least one of: a first capacitor coupled between a first connection pin and a corresponding first node, or a second capacitor coupled between a second connection pin and a corresponding second node.

In some implementations, the at least one driver circuit includes at least one of a transmitter (TX) driver circuit or a receiver (RX) driver circuit, and the transmitter driver circuit is configured to drive a first signal transmitted from the first device to the second device, and the receiver driver circuit is configured to drive a second signal transmitted from the second device to the first device.

In some implementations, the plurality of signal paths include multiple pairs of a transmitter signal path and a receiver signal path, each pair of the transmitter signal path and the receiver signal path being associated with a respective first component in the first device and a respective second component in the second device, and transmitter signal paths of the plurality of signal paths are associated with the transmitter driver circuit, and receiver signal paths of the plurality of signal paths are associated with the receiver driver circuit. A number of the transmitter signal paths is identical to a number of the receiver signal paths.

In some implementations, the signal is transferred according to Serial Advanced Technology Attachment (SATA) protocol, and the respective first component includes an SATA transmitter for the transmitter signal path and an SATA receiver for the receiver signal path, and the driver is configured to drive the signal according to the SATA protocol. The respective second component includes a device connector coupled to a storage device for receiving or transmitting the signal. The first device includes a platform controller configured to control communication between a processing device integrated in the first circuit board and one or more storage devices coupled to the second device.

In some implementations, the signal is transferred according to a Peripheral Component Interconnect Express (PCIe) protocol, and the respective first component includes a PCIe transmitter for the transmitter signal path and a PCIe receiver for the receiver signal path, and the driver is configured to drive the signal according to the PCIe protocol. The respective second component includes a device connector coupled to a PCIe device for receiving or transmitting the signal, and the first device includes a processing device configured to communicate with the PCIe device. In some implementations, the PCIe device includes a Non-Volatile Memory Express (NVMe) storage device, and the processing device is connected to the storage device according to an NVMe protocol.

In some implementations, the signal is transferred according to an ultra path interconnect (UPI) protocol, and the driver is configured to drive the signal according to the UPI protocol. The first device includes a first processing device, and the second device includes a second processing device. The respective first component includes a first UPI transmitter for the transmitter signal path and a first UPI receiver for the receiver signal path, and where the respective second component includes a second UPI receiver coupled to the first UPI transmitter through the transmitter signal path and a second UPI transmitter coupled to the first UPI receiver through the receiver signal path.

In some implementations, the first device is coupled to a first platform controller integrated on the first circuit board, and the second device is coupled to a second platform controller integrated on the second circuit board.

In some implementations, each of the at least one driver circuit includes: a linear driver coupled in each of the plurality of signal paths between the corresponding first connection pin and the corresponding second connection pin and configured to amplify a received signal and output an amplified signal.

In some implementations, each of the at least one driver circuit further includes: a control circuit coupled to the linear driver and configured to receive an I2C (inter-integrated circuit) command to control the linear driver to amplify the received signal based on the I2C command. At least one of the first device or the second device includes an I2C master configured to transmit the I2C command to the control circuit through a corresponding one of the first connector and the second connector, a corresponding electrical wire in the communication cable, and a corresponding connection pin on the driver circuit board.

In some implementations, the I2C master is configured to generate the I2C command based on a feedback from a power of the amplified signal, and where the control circuit is configured to control the linear driver to adjust an amplification factor of the signal based on the I2C command. In some implementations, the I2C master includes a microcontroller unit (MCU), and the control circuit includes a complex programmable logic device (CPLD).

In some implementations, each of the at least one driver circuit further includes a resistor coupled between the linear driver and a ground, and the resistor is configured to be adjustable to change a resistance of the resistor to control the linear driver to amplify the received signal.

In some implementations, a size of the driver circuit board is smaller than a size of the communication cable.

In some implementations, the driver further includes a protection layer covering the driver circuit board and the at least one driver circuit, the protection layer being made of an electrically insulated material.

In some implementations, the driver is configured to: in response to a power of the signal being smaller than a threshold, amplify the signal to be above the threshold.

Another aspect of the present disclosure features a communication cable, including: a plurality of first electrical wires; a plurality of second electrical wires; and a driver coupled between the plurality of first electrical wires and the plurality of second electrical wires. The driver includes a driver circuit board and at least one driver circuit integrated on the driver circuit board. The driver circuit board includes: one or more first connection pins coupled to one or more first electrical wires of the plurality of first electrical wires, and one or more second connection pins coupled to one or more second electrical wires of the plurality of second electrical wires, and the at least one driver circuit is configured to driver a signal transferred by the one or more first electrical wires and the one or more second electrical wires.

In some implementations, the one or more first connection pins and the one or more second connection pins are on a peripheral area of the driver circuit board, and each of the at least one driver circuit includes one or more first nodes coupled to the one or more first connection pins and one or more second nodes coupled to the one or more second connection pins.

In some implementations, the communication cable is configured to transfer the signal through a plurality of signal paths, and each of the plurality of signal paths is associated with a corresponding first electrical wire, a corresponding first connection pin, a corresponding first node, a corresponding second node, a corresponding second connection pin, and a corresponding second electrical wire.

In some implementations, along each of the plurality of signal paths, the driver further includes at least one of: a first capacitor coupled between a first connection pin and a corresponding first node, or a second capacitor coupled between a second connection pin and a corresponding second node.

In some implementations, the at least one driver circuit includes at least one of a transmitter (TX) driver circuit or a receiver (RX) driver circuit, and the transmitter driver circuit is configured to drive a first signal transmitted from the one or more first electrical wires to the one or more second electrical wires, and the receiver driver circuit is configured to drive a second signal transmitted from the one or more second electrical wires to the one or more first electrical wires. The plurality of signal paths include multiple pairs of a transmitter signal path and a receiver signal path. Transmitter signal paths of the plurality of signal paths are associated with the transmitter driver circuit, and receiver signal paths of the plurality of signal paths are associated with the receiver driver circuit, and a number of the transmitter signal paths is identical to a number of the receiver signal paths.

In some implementations, each of the at least one driver circuit includes: a linear driver coupled in each of corresponding signal paths between the corresponding first connection pin and the corresponding second connection pin and configured to drive a received signal and output a driven signal, and a control circuit coupled to the linear driver and configured to receive an I2C (inter-integrated circuit) command to control the linear driver to drive the received signal based on the I2C command.

In some implementations, each of the at least one driver circuit further includes a resistor coupled between the linear driver and a ground, and the resistor is configured to be adjustable to change a resistance of the resistor to control the linear driver to amplify the received signal.

In some implementations, the at least one driver circuit is configured to driver the signal according to a protocol, and the protocol includes a Serial Advanced Technology Attachment (SATA) protocol, a Peripheral Component Interconnect Express (PCIe) protocol, or an ultra path interconnect (UPI) protocol.

In some implementations, a size of the driver circuit board is smaller than a diameter of the communication cable.

In some implementations, the driver further includes a protection layer enclosing the driver circuit board and the at least one driver circuit, the protection layer being made of an electrically insulated material.

A further aspect of the present disclosure features a method including: transmitting a signal from a first device through a first connector to a communication cable, where the first device and the first connector are integrated on a first circuit board; driving the signal using a driver integrated in the communication cable; and transferring the driven signal by the communication cable through a second connector to a second device. The second device and the second connector are integrated on a second circuit board. The communication cable is coupled between the first connector on the first circuit board and the second connector on the second circuit board.

As used herein, the term “nominal/nominally” refers to a desired, or target, value of a characteristic or parameter for a component or a process step, set during the design phase of a product or a process, together with a range of values above and/or below the desired value. As used herein, the range of values can be due to slight variations in manufacturing processes or tolerances. As used herein, the term “about” indicates the value of a given quantity that can vary based on a particular technology node associated with the subject semiconductor device. Based on the particular technology node, the term “about” can indicate a value of a given quantity that varies within, for example, 10-30% of the value (e.g.,.+−0.10%, .+−0.20%, or .+−0.30% of the value). As used in this disclosure, the term “substantially” or “substantial” refers to a majority of, or mostly, as in at least about 50%, 60%, 70%, 80%, 90%, 95%, 96%, 97%, 98%, 99%, 99.5%, 99.9%, 99.99%, or at least about 99.999% or more. As used herein, the term “and/or” as used herein refers to and encompasses any and all possible combinations of one or more of the associated listed terms. For example, the term “A and/or B” means that either option A, option B, or both options A and B are possible, where A and B may be singular or plural.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 illustrates an example computing system for managing signal transmissions using a communication cable with an integrated driver.

FIG. 2A illustrates an example communication cable with an integrated driver.

FIG. 2B illustrates an example driver integrated in the communication cable of FIG. 2A.

FIG. 3 illustrates an example computing system for SATA data transmission using a communication cable with an integrated driver.

FIG. 4 illustrates an example computing system for PCIe data transmission using a communication cable with an integrated driver.

FIG. 5 illustrates an example computing system for UPI data transmission using a communication cable with an integrated driver.

FIG. 6 is a flowchart of an example process of a method of managing signal transmission with a communication cable with an integrated driver.

FIG. 7 illustrates an example computing device.

FIG. 8 illustrates an example computing system.

Like reference numbers and designations in the various drawings indicate like elements.

### DETAILED DESCRIPTION

Implementations of the present disclosure provide methods, devices, systems and techniques for managing signal transmissions using communication cables with integrated drivers, e.g., communication cables integrated with driver circuits for Serial Advanced Technology Attachment (SATA) or Peripheral Component Interconnect Express (PCIe) data transmissions between processors and storage devices, or Ultra Path Interconnect (UPI) data transmissions between multiple processors. Data denotes information conveyed in a signal and can be transmitted in the form of the signal. The signal can be a data signal or a command. The signal can be electrical, electromagnetic, acoustic, or optical. The communication cables can be electrical cables or optical cables. For illustration purposes, electrical wire cables are described in the present disclosure as an example of communication cables.

In some implementations, a computing system includes: a first device integrated on a first circuit board, a first connector integrated on the first circuit board and coupled to the first device, a second device integrated on a second circuit board, a second connector integrated on the second circuit board and coupled to the second device, and a communication cable coupled between the first connector and the second connector and configured to transfer a signal between the first device and the second device. The communication cable includes a driver integrated in the communication cable and configured to drive the signal transferred by the communication cable between the first device and the second device.

The subject matter described in this specification can be implemented to realize one or more of the following technical advantages and/or benefits. For example, in computing systems such as servers, the communication cables can be used to connect components on different circuit boards or components on a same board, which can not only save space but also allow for flexible system architecture configuration to suit different design needs. Thus, the communication cables can play an important role in server board connectivity, meeting diverse design and application needs. Moreover, when designing a computing system, a signal integrity of a communication cable can be evaluated and a length of the communication cable can be determined, which ensures efficient and reliable connections within the computing system and adapts to the needs of high-speed data transmission.

Due to a fixed cable length after configuration, pure high-speed communication cables may not meet the specifications after the requirements change during development. Additionally, the system configuration and hardware architecture are fixed and cannot be changed flexibly. In contrast, the communication cables with integrated drivers implemented herein can avoid redesign circuit boards and cables, thereby avoiding delay on a project schedule or challenges for development process. The techniques implemented herein can solve the problem that the system architecture is fixed, the hardware architecture is fixed, the length of the high-speed cable is fixed, and the signal driving force is insufficient or the demand changes need to flexibly adjust the hardware system architecture. The techniques provide a flexible solution that allows adjustments to be made under a fixed architecture, ensuring that the system can be adapted to new requirements without affecting overall schedule and performance. If the signal quality is poor, the driving power is insufficient, the system configuration needs to be changed abruptly after the system development phase is completed, or problems can arise, such as failure to verify, poor hard disk execution, and easy crashing, the techniques can address the above problems or challenges, e.g., by using the driver integrated in the communication cables to increase or amplify a signal power or quality, without major changes to the system architecture, making the system more flexible, more stable, and able to respond quickly to changes in requirements.

In some implementations, the driver can be integrated in the communication cable. The driver can include a driver circuit board (e.g., a printed circuit board—PCB) and at least one driving circuit integrated on the driver circuit board. The driver can be an integrated chip. The driver circuit board can have a small area that can be comparable to a diameter of the communication cable. The driver does not take up too much system space and cable routing space. This design enhances signal drive without compromising the overall layout and space utilization of the system. In some implementations, a communication cable includes a driver configured for a corresponding protocol, e.g., SATA protocol, PCIe protocol, or UPI protocol. In some implementations, a communication cable includes two or more drivers each configured for a corresponding protocol, and the two or more drivers can be arranged in different locations in the communication cable. In some implementations, a communication cable includes a driver configured for a particular function, e.g., signal amplification, or a driver configured for two or more functions, e.g., signal amplification, filtering, noise processing, and/or data processing. In some implementations, a communication cable includes or two or more drivers configured for two or more functions according to a particular protocol.

The techniques can be implemented for any suitable signal transmission, e.g., electrical signal or optical signal, and can be implemented for any suitable protocol for data transmission, e.g., SATA protocol, PCIe protocol, or UPI protocol.

The following detailed description is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

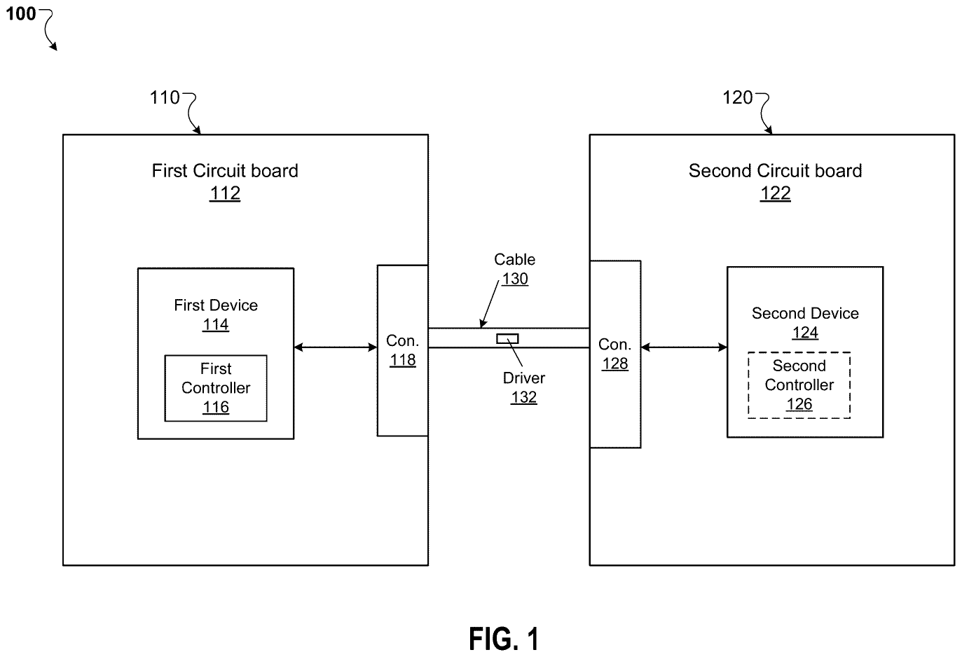

FIG. 1 illustrates an example computing system 100 for managing signal transmissions using a communication cable 130 with an integrated driver 132. The computing system can be a server. As illustrated in FIG. 1, the computing system 100 can include a first assembly 110 and a second assembly 120 that are connected using the communication cable 130. The integrated driver 132 can be configured to drive a signal transferred through the communication cable 130 between the first assembly 110 and the second assembly 120, e.g., increase a power or quality of the signal.

In some implementations, the first assembly 110 includes a first circuit board 112 and one or more first devices integrated on the first circuit board 112. The first circuit board 112 can be a printed circuit board (PCB), and the first assembly 110 can be a PCB assembly (PCBA). In some implementations, the second assembly 120 includes a second circuit board 122 and one or more second devices integrated on the second circuit board 122. The second circuit board 122 can also be a printed circuit board (PCB), and the second assembly 120 can also be a PCB assembly (PCBA). The communication cable 130 can connect the first circuit board 112 and the second circuit board 122 and is configured to transfer signals between the one or more first devices of the first assembly 110 on the first circuit board 112 and the one or more second devices of the second assembly 120 on the second circuit board 122.

In some implementations, the one or more first devices include a processing device, e.g., a central processing unit (CPU), a graphics processing unit (GPU), a multi-core Processor, a data processing unit (DPU), a tensor processing unit (TPU), a quantum processing unit (QPU), an Application Specific Integrated Circuit (ASIC), a Field Programmable Gate Array (FPGA), a microprocessor, or any other processing device, or a combination thereof. The first circuit board 112 can be a processing circuit board or a motherboard. In some implementations, the one or more first devices include a platform controller, e.g., a Platform Controller Hub (PCH). The platform controller can be coupled to a processing device (e.g., a CPU), and can control data paths and support functions used in conjunction with the processing device. In some implementations, the platform controller includes clocking (the system clock), Flexible Display Interface (FDI), and/or Direct Media Interface (DMI).

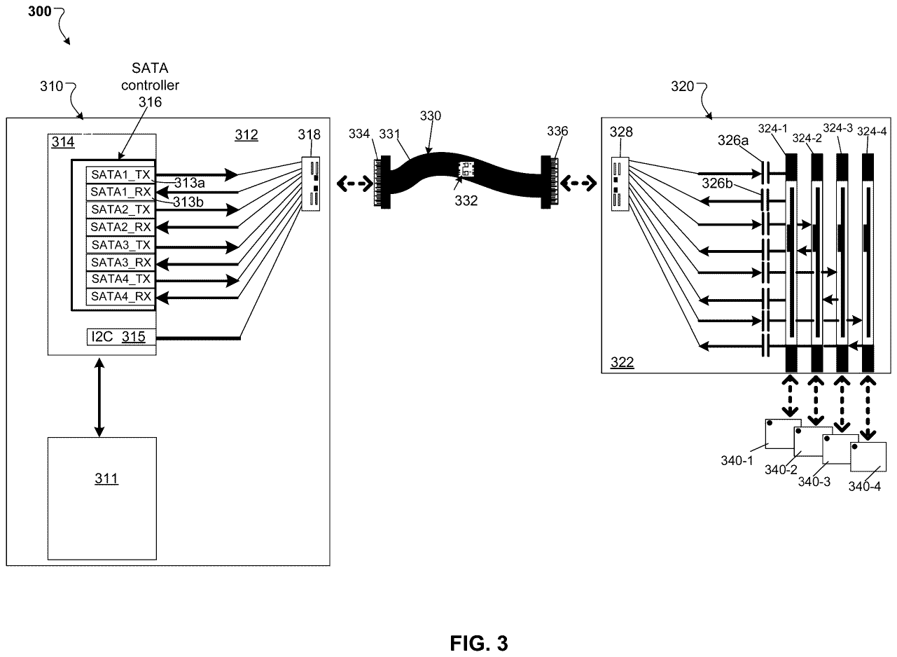

As illustrated in FIG. 1, the one or more first devices can include a first device 114 and a first connector 118 that is configured to couple the first device 114 with the communication cable 130. In some implementations, e.g., as illustrated with further details in FIG. 3, the first device 114 is a platform controller (e.g., PCH) coupled to a processing device (e.g., CPU) by DMI on the first circuit board 112. The first device 114 can use an SATA protocol to connect the processing device on the first circuit board 112 to one or more storage devices, e.g., hard disk drives (HDDs), solid-state drives (SSDs), or optical drives. The one or more second devices on the second circuit board 122 can include a second device 124 that can include one or more device connectors for connecting to the one or more storage devices. In some examples, a device connector includes an SFF-8643 connector.

In some implementations, the first device 114 includes a first controller 116 that can include multiple pairs of SATA transmitter (TX) and SATA receiver (RX). Each of the SATA TXs and the SATA RXs can be associated with a signal path. Each device connector can be associated with a pair of SATA TX and SATA RX. An SATA TX is configured to transmit a signal from the first device 114 (e.g., based on data from the processing device) through the first connector 118, the communication cable 130, and a second connector 128 integrated on the second circuit board 122 to the second device 124. An SATA RX is configured to receive a signal from the second device 124 (e.g., based on data from the one or more storage devices) through the second connector 128, the communication cable 130, and the first connector 118, to the first device 114. Each of the first connector 118 and the second connector 128 can be configured to transmit SATA data or a signal according to the SATA protocol. In some examples, the first connector 118 or the second connector 128 includes a SLIMline connector such as a SlimSAS 8i connector. The first connector 118 or the second connector 128 can use an Integrated Drive Electronics (IDE) interface.

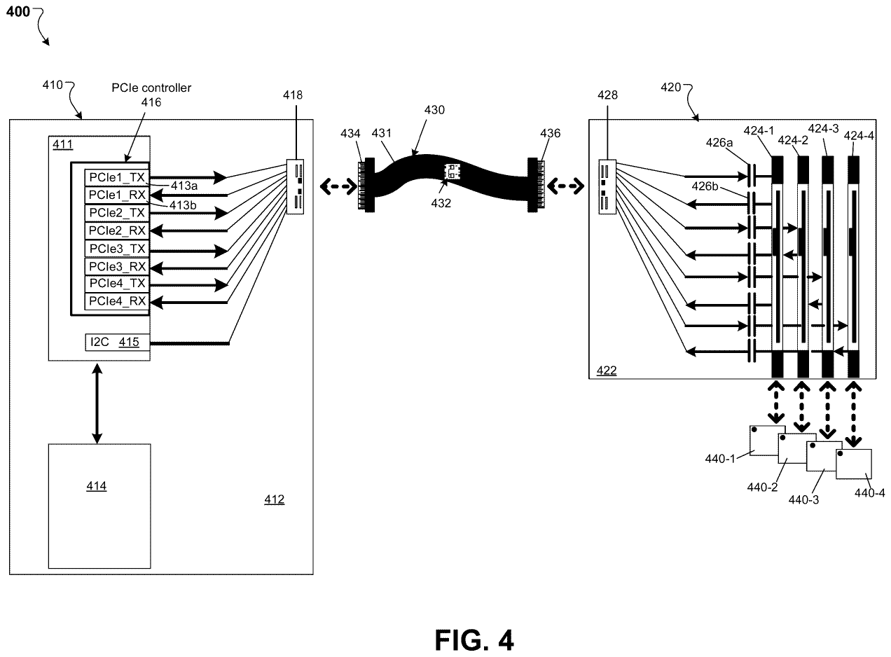

In some implementations, e.g., as illustrated with further details in FIG. 4, the first device 114 is a processing device (e.g., a CPU), and can use a Peripheral Component Interconnect Express (PCIe) topology to accommodate one or more external devices external to the first circuit board 112. The external devices can include expansion cards, such as GPUs, graphics cards, network cards, or storage cards. In some examples, the external devices can include Non-Volatile Memory Express (NVMe) devices, PCIe x8 Riser cards, and PCIe x16 Riser cards. The external devices can have various bandwidth, such as x4, x8, or x16. The second device 124 on the second circuit board 122 can include one or more device connectors for connecting to the one or more external devices (e.g., NVMe devices). In some examples, a device connector includes an SFF-8643 connector.

In some implementations, the first device 114 includes a first controller 116 that can include multiple pairs of PCIe transmitter (TX) and PCIe receiver (RX). Each of the PCIe TXs and the PCIe RXs can be associated with a signal path. Each device connector can be associated with a pair of PCIe TX and PCIe RX. A PCIe TX is configured to transmit a signal from the first device 114 (e.g., a processor) through the first connector 118, the communication cable 130, and the second connector 128 to the second device 124. A PCIe RX is configured to receive a signal from the second device 124 (e.g., based on data from the one or more external devices) through the second connector 128, the communication cable 130, and the first connector 118, to the first device 114. Each of the first connector 118 and the second connector 128 can be configured to transmit PCIe data or a signal according to the PCIe protocol. In some examples, the first connector 118 or the second connector 128 includes a SLIMline connector such as a SlimSAS 8i connector. The first connector 118 or the second connector 128 can use an Integrated Drive Electronics (IDE) interface.

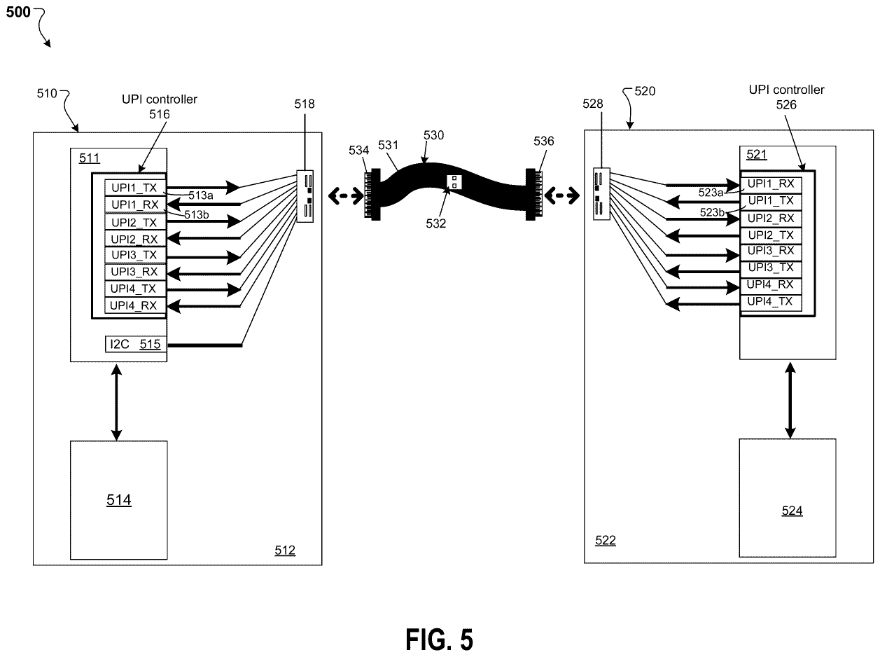

In some implementations, e.g., as illustrated with further details in FIG. 5, the first device 114 is a first processing device (e.g., CPU), and the second device 124 is a second processing device (e.g., CPU). The first device 114 and the second device 124 can be connected according to a UPI protocol. UPI is a low-latency coherent interconnect for scalable multiprocessor systems with a shared address space. Each of a first controller 116 in the first device 114 and a second controller 126 in the second device 124 can include multiple pairs of UPI TXs and UPI RXs. A signal path is associated with a corresponding pair of a UPI TX in the first controller 116 and a UPI RX in the second controller 126. A UPI TX in the first controller 116 is configured to transmit a signal from the first device 114 (e.g., a processor) through the first connector 118, the communication cable 130, the second connector 128 to a corresponding UPI RX in the second device 124. A UPI RX in the first device 114 is configured to receive a signal from a corresponding UPI TX in the second device 124 through the second connector 128, the communication cable 130, and the first connector 118. Each of the first connector 118 and the second connector 128 can be configured to transmit UPI data or a signal according to the UPI protocol. In some examples, the first connector 118 or the second connector 128 includes a SLIMline connector such as a SlimSAS 8i connector. The first connector 118 or the second connector 128 can use an Integrated Drive Electronics (IDE) interface.

The communication cable 130 can be configured to transfer signals between the first device 114 and the second device 124, e.g., according to SATA protocol, PCIe protocol, or UPI protocol as noted above. The driver 132 can be configured to drive the signals transferred by the communication cable 130, e.g., SATA data, PCIe data, or UPI data. Each of the first connector 118 and the second connector 128 can be configured for one or more protocols, e.g., SATA protocol, PCIe protocol, and/or UPI protocol.

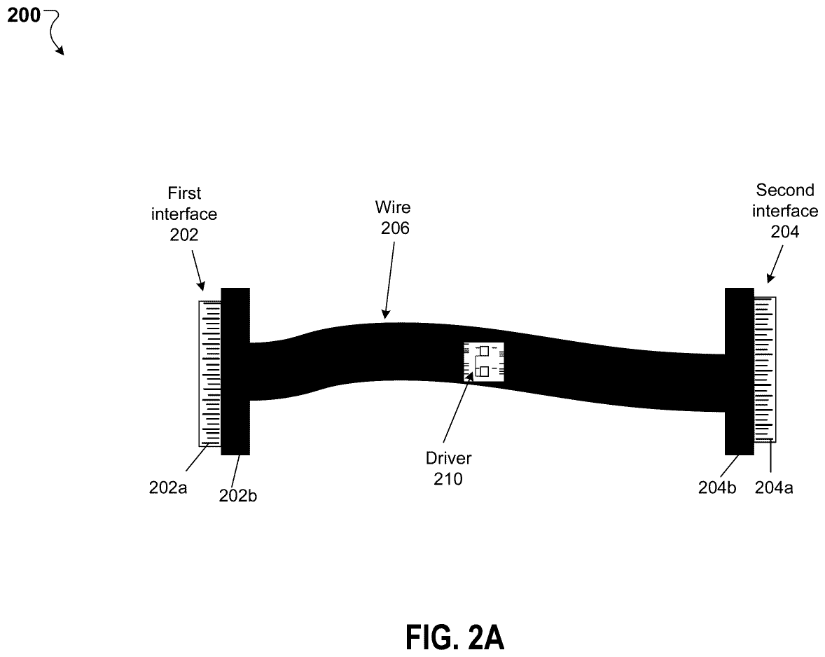

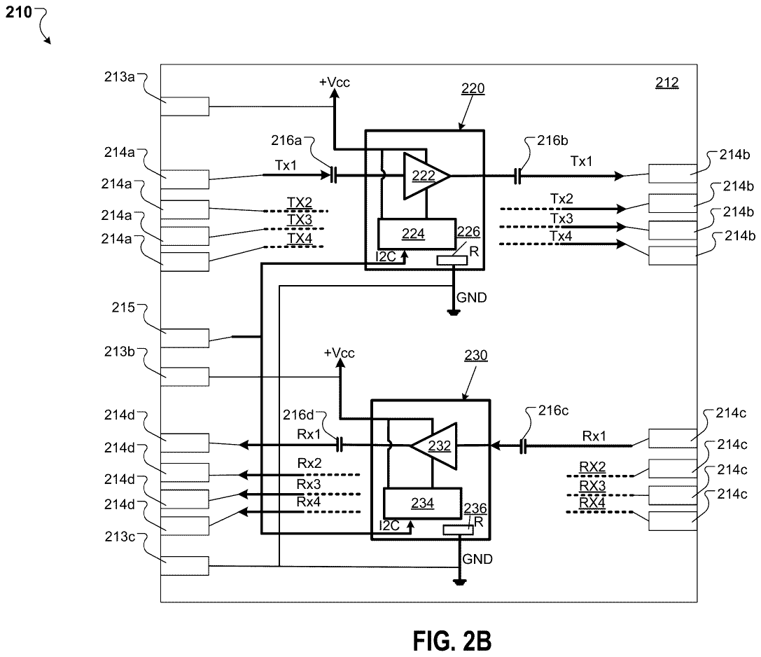

FIG. 2A illustrates an example communication cable 200 with an integrated driver 210. The communication cable 200 can be implemented as the communication cable 130 of FIG. 1 in a computing system (e.g., the computing system 100 of FIG. 1), and the driver 210 can be implemented as the driver 132 of FIG. 1. The communication cable 200 can be used for connection between circuit boards or connections within a circuit board. The communication cable 200 can be an electrical cable such as an electrical wire cable, or an optical cable such as an optical fiber cable. For illustration purpose, an electrical wire cable is described as an example of the communication cable 200. The communication cable 200 can have any suitable shape, e.g., a flat shape, or a tubular shape. A cross section of the communication cable 200 can be any suitable shape, e.g., a circle, a rectangular, a square, an ellipse, or a polygon.

As illustrated in FIG. 2A, the communication cable 200 includes a first interface 202 and a second interface 204 on opposite ends of the communication cable 200. The communication cable 200 can further include a plurality of electrical wires 206 coupled between the first interface 202 and the second interface 204. A number of the plurality of electrical wires 206 can be, e.g., 10, 20, 30, 40, 50, 60, 70, 80, 90, or 100 or more.

In some implementations, the first interface 202 includes a first pin slot 202a and a first wire coupler 202b. The first wire coupler 202b is configured to individually couple first ends of the plurality of electrical wires 206 to respective pins on the first pin slot 202a. The first pin slot 202a includes a number of isolated electrical pins for electrically coupling with a first connector, e.g., the first connector 118 of FIG. 1, such that signals can be transferred between the first connector and the communication cable 200. Similarly, the second interface 204 includes a second pin slot 204a and a second wire coupler 204b. The second wire coupler 204b is configured to individually couple second ends of the plurality of electrical wires 206 to respective pins on the second pin slot 204a. The second pin slot 204a includes a number of isolated electrical pins for electrically coupling with a second connector, e.g., the second connector 128 of FIG. 1, such that signals can be transferred between the second connector and the communication cable 200.

As illustrated in FIG. 2A, the driver 210 is integrated in the communication cable 200. The driver 210 can include a driver circuit board and at least one driving circuit integrated on the driver circuit board, e.g., as illustrated in FIG. 2B. The driver 210 can be an integrated chip. The driver 210 can have a small area, e.g., about 10 mm×55 mm, and can have a size (e.g., a width or length) comparable to a size (e.g., a diameter) of the communication cable 200 (or the diameter of a bundle of the electrical wires 206). In such a way, the driver 210 does not take up too much system space and cable routing space, which can enhance signal drive without compromising the overall layout and space utilization of the system (e.g., the computing system 100 of FIG. 1).

FIG. 2B illustrates an example of the driver 210 integrated in the communication cable 200 of FIG. 2A. The driver 210 can includes a driver circuit board 212 (e.g., a printed circuit board—PCB) and one or more driving circuits, e.g., a transmitter (TX) driver circuit 220 and a receiver (RX) driver circuit 230, that are integrated on the driver circuit board 212. The one or more driver circuits are configured to driver a signal according to a protocol that can include a Serial Advanced Technology Attachment (SATA) protocol, a Peripheral Component Interconnect Express (PCIe) protocol, or an ultra path interconnect (UPI) protocol. The signal can be amplified after passing through the driver 210, which effectively improves the signal quality and reduces the loss of signal transmission.

The driver circuit board 212 can include first connection pins on a first side of the driver circuit board 212, and second connection pins on a second side of the driver circuit board 212. The first and second connection pins can include signal pins 214a, 214d on the first side and signal pins 214b, 214c on the second side. The first and second connection pins can also include power pins 213a (e.g., for receiving a supply voltage Vcc), 213b (for receiving a supply voltage Vcc), 213c (e.g., for coupling to a ground), and a control pin 215 for receiving a control signal or a command (such as an I2C command).

To integrate the driver 210 into the communication cable, the communication cable 200 can include first electrical wires having first ends coupled to the first interface 202 and second ends coupled to the first connection pins of the driver circuit board 212. The communication cable 200 can further include second electrical wires having first ends coupled the second interface 204 and second ends coupled to the second connection pins of the driver circuit board 212. Each of the driver circuits 220, 230 can include first nodes coupled to the first connection pins and second nodes coupled to the second connection pins. The transmitter driver circuit 220 can be configured to drive a first signal transmitted from the first electrical wires to the second electrical wires, and the receiver driver circuit 230 can be configured to drive a second signal transmitted from the second electrical wires to the first electrical wires. The connection pins can be hotbars for soldering the electrical wires. As no connectors are used, the loss of high-speed signals can be reduced.

The communication cable 200 can transfer signals through a plurality of signal paths, e.g., 8 signal paths as illustrated in FIG. 2B. Each of the plurality of signal paths is associated with a corresponding first electrical wire, a corresponding first connection pin, a corresponding first node, a corresponding driving circuit, a corresponding second node, a corresponding second connection pin, and a corresponding second electrical wire. The plurality of signal paths can include TX signal paths and RX signal paths. A number of the TX signal paths and a number of RX signal paths can be identical, e.g., 4 TX signal paths and 4 RX signal paths.

In some implementations, along each TX signal path, the driver 210 further includes a first capacitor 216a coupled between a first connection pin 214a and a corresponding first node of the TX driver circuit 220, and a second capacitor 216b coupled between a second connection pin 214b and a corresponding second node of the TX driver circuit 220. Similarly, along each RX signal path, the driver 210 further includes a third capacitor 216c coupled between a third connection pin 214c and a corresponding third node of the RX driver circuit 230, and a fourth capacitor 216d coupled between a fourth connection pin 214d and a corresponding fourth node of the RX driver circuit 230. The capacitor 216a, 216b, 216c, 216d in the driver 210 can be a cross-linked capacitor that can be used to block direct current (DC) signals in a signal path.

The plurality of signal paths can include multiple pairs of a transmitter signal path and a receiver signal path, and each pair of the transmitter signal path and the receiver signal path can be associated with a respective first component in a first device (e.g., the first device 114 of FIG. 1) and a respective second component in a second device (e.g., the second device 124 of FIG. 1), the first device and the second device being connected by the communication cable 200, e.g., as illustrated with further details in FIGS. 3, 4, or 5.

In some implementations, e.g., as illustrated in FIG. 2B, the TX driver circuit 220 includes a linear driver 222 coupled in each of the TX signal paths between the corresponding first connection pin 214a and the corresponding second connection pin 214b and configured to drive (e.g., amplify) a received signal and output a driven signal. The TX driver circuit 220 can further includes a control circuit 224 coupled to the linear driver 222 and configured to receive an I2C (inter-integrated circuit) command to control the linear driver 222 to drive the received signal based on the I2C command, e.g., through the control pin 215. The I2C command can be generated by a host device (e.g., the first device 110 of FIG. 1) based on a feedback signal from the communication cable 200, such that the TX driver circuit 220 can be dynamically adjusted based on a requirement or need of the system. For example, the TX driver circuit 220 can amplify the signal, and the amplification factor may be not a fixed value, which may be determined by the situation through the I2C feedback of the TX driver circuit 220, and then the host device can adjust the amplification factor of the TX driver circuit 220.

The linear driver 222 can be an operational amplifier (OPA). The control circuit 224 can be a digital circuit, e.g., a complex programmable logic device (CPLD). Each of the linear driver 222 and the control circuit 224 can be coupled to a power pin 213a to receive the supply voltage (e.g., +Vcc). In some implementations, the TX driver circuit 220 includes a resistor 226 coupled to the linear driver 222. The resistor 226 can be coupled to a ground by a power pin 213c. The resistor 226 can be adjustable to change a resistance of the resistor 226 to control the linear driver 222 to drive the received signal. The resistor 226 can be adjusted manually or automatically by a control signal.

In some implementations, e.g., as illustrated in FIG. 2B, the RX driver circuit 230 includes a linear driver 232 coupled in each of the RX signal paths between the corresponding third connection pin 214c and the corresponding fourth connection pin 214d and configured to drive (e.g., amplify) a received signal (e.g., from the second device 122 of FIG. 1) and output a driven signal. The RX driver circuit 230 can further includes a control circuit 234 coupled to the linear driver 232 and configured to receive an I2C (inter-integrated circuit) command to control the linear driver 232 to drive the received signal based on the I2C command, e.g., through the control pin 215. The I2C command can be generated by a host device (e.g., the first device 110 of FIG. 1) based on a feedback signal from the communication cable 200, such that the RX driver circuit 230 can be dynamically adjusted based on a requirement or need of the system. For example, the RX driver circuit 230 can amplify the signal, and the amplification factor may be not a fixed value, which may be determined by the situation through the I2C feedback of the RX driver circuit 230, and then the host device can adjust the amplification factor of the RX driver circuit 230.

The linear driver 232 can be an operational amplifier (OPA). The control circuit 234 can be a digital circuit, e.g., a complex programmable logic device (CPLD). Each of the linear driver 232 and the control circuit 234 can be coupled to a power pin 213b to receive the supply voltage (e.g., +Vcc). In some implementations, the RX driver circuit 230 includes a resistor 236 coupled to the linear driver 232. The resistor 236 can be coupled to the ground by the power pin 213c. The resistor 236 can be adjustable to change a resistance of the resistor 236 to control the linear driver 232 to drive the received signal. The resistor 236 can be adjusted manually or automatically by a control signal.

In some implementations, the driver 210 includes a protection layer enclosing the driver circuit board 212 and the one or more driving circuits. The protection layer can include an electrically insulating material. The driver 210 can be reserved for sufficient length to prevent tearing. The driver 210 can effectively improve the signal quality and maintain the flexibility and stability of the system.

FIG. 3 illustrates an example computing system 300 for SATA data transmission using a communication cable 330 with an integrated driver 332. The computing system 300 can be the computing system 100 of FIG. 1. The communication cable 330 can be same as, or similar to, the communication cable 130 of FIG. 1, or 200 of FIG. 2A-2B. The driver 332 can be same as, or similar to, the driver 132 of FIG. 1, or 210 of FIGS. 2A-2B. The communication cable 330 can be configured to transfer a signal according to SATA protocol, and the driver 332 can be configured to drive the signal according to the SATA protocol. The driver 332 can be a SATA driver. The driver 332 can include a driver circuit board (e.g., the driver circuit board 212 of FIG. 2) and one or more driver circuits (e.g., the TX driver circuit 220 and/or the RX driver circuit 230 of FIG. 2). The communication cable 330 can enable high speed SATA data transmission with high signal quality and strength.

The computing system 300 includes a first assembly 310 (e.g., the first assembly 110 of FIG. 1) and a second assembly 320 (e.g., the second assembly 120 of FIG. 1) that are connected by the communication cable 330. Each of the first assembly 310 and the second assembly 320 can be a PCBA assembly.

As illustrated in FIG. 3, the first assembly 310 includes a first circuit board 312 (e.g., the first circuit board 112 of FIG. 1), a processing device 311, and a platform controller 314. The processing device 311 and the platform controller 314 are integrated on the first circuit board 312 and can communicate, e.g., via Direct Media Interface (DMI). The first assembly 310 can further include a first connector 318 (e.g., the first connector 118 of FIG. 1) integrated on the first circuit board 312 and coupled to the platform controller 314.

The second assembly 320 includes a second circuit board 322 (e.g., the second circuit board 122 of FIG. 1), a second connector 328 (e.g., the second connector 128 of FIG. 1), and device connectors 324-1, 324-2, 324-3, 324-4 (referred to generally as device connectors 324 and individually as a device connector 324). The second connector 328 and the device controllers 324 are integrated on the second circuit board 322. The second connector 328 is coupled to the device controllers 324. Each device controller 324-1, 324-2, 324-3, 324-4 can be respectively coupled with a corresponding storage device 340-1, 340-2, 340-3, 340-4 (referred to generally as storage devices 340 and individually as a storage device 340), e.g., a hard disk drive (HDD), a solid-state drives (SSD), or an optical drive. In some examples, a device connector 324 includes an SFF-8643 connector.

The communication cable 330 includes a first interface 334 (e.g., the first interface 202 of FIG. 2A), a second interface 336 (e.g., the second interface 204 of FIG. 2A), and electrical wires 331 (e.g., the electrical wires 206 of FIG. 2A) that are coupled between the first interface 334 and the second interface 336. The communication cable 330 is coupled to the first connector 318, e.g., by connecting the first interface 334 with the first connector 318, and is coupled to the second connector 328, e.g., by connecting the second interface 336 with the second connector 328. In some examples, the first connector 318 or the second connector 328 includes a SLIMline connector such as a SlimSAS 8i connector. The first connector 318 or the second connector 328 can use an Integrated Drive Electronics (IDE) interface.

In some implementations, the processing device 311 includes, e.g., a central processing unit (CPU), a graphics processing unit (GPU), a multi-core Processor, a data processing unit (DPU), a tensor processing unit (TPU), a quantum processing unit (QPU), an Application Specific Integrated Circuit (ASIC), a Field Programmable Gate Array (FPGA), a microprocessor, or any other processing device, or a combination thereof. The first circuit board 312 can be a processing circuit board or a motherboard. In some implementations, the platform controller 314, e.g., a Platform Controller Hub (PCH). The platform controller 314 can control data paths and support functions used in conjunction with the processing device 311. In some implementations, the platform controller includes clocking (the system clock), Flexible Display Interface (FDI), and/or Direct Media Interface (DMI).

As illustrated in FIG. 3, the platform controller 314 can be same as, or similar to, the first device 114 of FIG. 1. The platform controller 314 can use an SATA protocol to connect the processing device 311 on the first circuit board 312 to the storage devices 340 coupled to the device connectors 324 integrated on the second circuit board 322.

In some implementations, as illustrated in FIG. 3, the platform controller 314 includes an SATA controller 316 (e.g., the first controller 116 of FIG. 1) that can include multiple pairs (e.g., 4 pairs) of SATA transmitter (TX) 313a and SATA receiver (RX) 313b. Each of the SATA TXs 313a and the SATA RXs 313b can be associated with a signal path. Each device connector 324 can be associated with a pair of SATA TX 313a and SATA RX 313b. Along a TX signal path, an SATA TX 313a is configured to transmit a signal from the platform controller 314 (e.g., based on data from the processing device 311) through the first connector 318, the communication cable 330, and the second connector 328 to the corresponding device controller 324 and then to the corresponding storage device 340. The signal can be driven (or amplified) by a TX driver circuit in the driver 332, e.g., the TX driver circuit 220 of FIG. 2B. In some implementations, a capacitor 326a is coupled between the second connector 328 and the corresponding device controller 324, e.g., to block DC signals, in the TX signal path.

Similarly, along a RX signal path, an SATA RX 313b is configured to receive a signal from a corresponding device controller 324 (e.g., based on data from a corresponding storage device 340) through the second connector 328, the communication cable 330, and the first connector 318, to the SATA RX 313b. The signal can be driven (or amplified) by a RX driver circuit in the driver 332, e.g., the RX driver circuit 230 of FIG. 2B. In some implementations, a capacitor 326b is coupled between the corresponding device controller 324 and the second connector 328, e.g., to block DC signals, in the RX signal path.

In some implementations, the driver circuit (e.g., TX or RX driver circuit) in the driver 332 includes a linear driver (e.g., the linear driver 222 of FIG. 2B) and a control circuit (e.g., the control circuit 224 of FIG. 2B) coupled to the linear driver. The linear driver can be an operational amplifier (OPA). The control circuit can be a digital circuit, e.g., a complex programmable logic device (CPLD). In some implementations, the platform controller 314 in the first assembly 310 includes a I2C master 315 (e.g., a microcontroller). The I2C master 315 in the platform controller 314 can be coupled to the control circuit in the driver 332 through the first connector 318, the first interface 334 of the communication cable, and a corresponding connection pin (e.g., the connection pin 215 of FIG. 2) on the driver circuit board of the driver 332.

The control circuit can be configured to receive an I2C command (e.g., from the I2C master 315) to control the linear driver to drive the received signal based on the I2C command. The I2C master 315 is configured to generate the I2C command based on a feedback signal from the communication cable 330, such that the driver circuit (e.g., RX or TX driver circuit) can be dynamically adjusted based on a requirement or need of the system. For example, the driver circuit can amplify the signal, and the amplification factor may be not a fixed value, which may be determined by the situation through the I2C feedback of the driver circuit, and then the I2C master 315 can adjust the amplification factor of the driver circuit.

In some implementations, the driver circuit (e.g., the TX or RX driver circuit) includes a resistor (e.g., the resistor 236 of FIG. 2B) coupled to the linear driver. The resistor can be coupled to the ground (e.g., by the power pin 213c of FIG. 2B). The resistor can be adjustable to change a resistance of the resistor to control the linear driver to drive the received signal. The resistor can be adjusted manually or automatically by a control signal.

FIG. 4 illustrates an example computing system 400 for PCIe data transmission using a communication cable 430 with an integrated driver 432. The computing system 400 can be the computing system 100 of FIG. 1. The communication cable 430 can be same as, or similar to, the communication cable 130 of FIG. 1, or 200 of FIG. 2A-2B. The driver 432 can be same as, or similar to, the driver 132 of FIG. 1, or 210 of FIGS. 2A-2B. The communication cable 430 can be configured to transfer a signal according to PCIe protocol, and the driver 432 can be configured to drive the signal according to the PCIe protocol. The driver 432 can be a PCIe driver. The driver 432 can include a driver circuit board (e.g., the driver circuit board 212 of FIG. 2) and one or more driver circuits (e.g., the TX driver circuit 220 and/or the RX driver circuit 230 of FIG. 2). The communication cable 430 can enable high speed PCIe data transmission with high signal quality and strength.

The computing system 400 includes a first assembly 410 (e.g., the first assembly 110 of FIG. 1) and a second assembly 420 (e.g., the second assembly 120 of FIG. 1) that are connected by the communication cable 430. Each of the first assembly 410 and the second assembly 420 can be a PCBA assembly.

As illustrated in FIG. 4, the first assembly 410 includes a first circuit board 412 (e.g., the first circuit board 112 of FIG. 1), a processing device 411, and a platform controller 414. The processing device 411 and the platform controller 414 are integrated on the first circuit board 412 and can communicate, e.g., via Direct Media Interface (DMI). The first assembly 410 can further include a first connector 418 (e.g., the first connector 118 of FIG. 1 or the 318 of FIG. 3) integrated on the first circuit board 412 and coupled to the platform controller 414.

The second assembly 420 includes a second circuit board 422 (e.g., the second circuit board 122 of FIG. 1), a second connector 428 (e.g., the second connector 128 of FIG. 1), and device connectors 424-1, 424-2, 424-3, 424-4 (referred to generally as device connectors 424 and individually as a device connector 424). The second connector 428 and the device controllers 424 are integrated on the second circuit board 422. The second connector 428 is coupled to the device controllers 424. Each device controller 424-1, 424-2, 424-3, 424-4 can be respectively coupled with a corresponding PCIe device 440-1, 440-2, 440-3, 440-4 (referred to generally as PCI devices 440 and individually as a PCIe device 440), e.g., a GPU, a graphics card, a network card, or a storage card. In some examples, the PCIe devices 440 can include Non-Volatile Memory Express (NVMe) devices, PCIe x8 Riser cards, and PCIe x16 Riser cards. In some examples, the device connector 424 includes an SFF-8643 connector.

The communication cable 430 includes a first interface 434 (e.g., the first interface 202 of FIG. 2A), a second interface 436 (e.g., the second interface 204 of FIG. 2A), and electrical wires 431 (e.g., the electrical wires 206 of FIG. 2A) that are coupled between the first interface 434 and the second interface 436. The communication cable 430 is coupled to the first connector 418, e.g., by connecting the first interface 434 with the first connector 418, and is coupled to the second connector 428, e.g., by connecting the second interface 436 with the second connector 428. In some examples, the first connector 418 or the second connector 428 includes a SLIMline connector such as a SlimSAS 8i connector. The first connector 418 or the second connector 428 can use an Integrated Drive Electronics (IDE) interface.

In some implementations, the processing device 411 includes, e.g., a central processing unit (CPU), a graphics processing unit (GPU), a multi-core Processor, a data processing unit (DPU), a tensor processing unit (TPU), a quantum processing unit (QPU), an Application Specific Integrated Circuit (ASIC), a Field Programmable Gate Array (FPGA), a microprocessor, or any other processing device, or a combination thereof. The first circuit board 412 can be a processing circuit board or a motherboard. In some implementations, the platform controller 414, e.g., a Platform Controller Hub (PCH). The platform controller 414 can control data paths and support functions used in conjunction with the processing device 411. In some implementations, the platform controller includes clocking (the system clock), Flexible Display Interface (FDI), and/or Direct Media Interface (DMI).

As illustrated in FIG. 4, the processing device 411 can be same as, or similar to, the first device 114 of FIG. 1. The processing device 411 can use a PCIe protocol to connect the processing device 411 on the first circuit board 412 to the PCIe devices 440 coupled to the device connectors 424 integrated on the second circuit board 422.

In some implementations, as illustrated in FIG. 4, the processing device 411 includes a PCIe controller 416 (e.g., the first controller 116 of FIG. 1) that can include multiple pairs (e.g., 4 pairs) of PCIe transmitter (TX) 413a and PCIe receiver (RX) 413b. Each of the PCIe TXs 413a and the PCIe RXs 413b can be associated with a signal path. Each device connector 424 can be associated with a pair of PCIe TX 413a and PCIe RX 413b. Along a TX signal path, a PCIe TX 413a is configured to transmit a signal from the processing device 414 through the first connector 418, the communication cable 430, and the second connector 428 to the corresponding device controller 424 and then to the corresponding PCIe device 440. The signal can be driven (or amplified) by a TX driver circuit in the driver 432, e.g., the TX driver circuit 220 of FIG. 2B. In some implementations, a capacitor 426a is coupled between the second connector 428 and the corresponding device controller 424, e.g., to block DC signals, in the TX signal path.

Similarly, along a RX signal path, a PCIe RX 413b is configured to receive a signal from a corresponding device controller 424 (e.g., based on data from a corresponding PCIe device 440) through the second connector 428, the communication cable 430, and the first connector 418, to the PCIe RX 413b. The signal can be driven (or amplified) by a RX driver circuit in the driver 432, e.g., the RX driver circuit 230 of FIG. 2B. In some implementations, a capacitor 426b is coupled between the corresponding device controller 424 and the second connector 428, e.g., to block DC signals, in the RX signal path.

In some implementations, the driver circuit (e.g., the TX or RX driver circuit) in the driver 432 includes a linear driver (e.g., the linear driver 222 of FIG. 2B) and a control circuit (e.g., the control circuit 224 of FIG. 2B) coupled to the linear driver. The linear driver can be an operational amplifier (OPA). The control circuit can be a digital circuit, e.g., a complex programmable logic device (CPLD). In some implementations, the processing device 411 in the first assembly 410 includes a I2C master 415 (e.g., a microcontroller). The I2C master 415 in the processing device 411 can be coupled to the control circuit in the driver 432 through the first connector 418, the interface (e.g., the first interface 434) of the communication cable 430, and a corresponding connection pin (e.g., the connection pin 215 of FIG. 2) on the driver circuit board of the driver 432.

The control circuit can be configured to receive an I2C command (e.g., from the I2C master 415) to control the linear driver to drive the received signal based on the I2C command. The I2C master 415 is configured to generate the I2C command based on a feedback signal from the communication cable 430, such that the driver circuit (e.g., RX or TX) can be dynamically adjusted based on a requirement or need of the system. For example, the driver circuit can amplify the signal, and the amplification factor may be not a fixed value, which may be determined by the situation through the I2C feedback of the driver circuit, and then the I2C master 415 can adjust the amplification factor of the driver circuit.

In some implementations, the driver circuit (e.g., the TX or RX driver circuit) includes a resistor (e.g., the resistor 236 of FIG. 2B) coupled to the linear driver. The resistor can be coupled to the ground (e.g., by the power pin 213c of FIG. 2B). The resistor can be adjustable to change a resistance of the resistor to control the linear driver to drive the received signal. The resistor can be adjusted manually or automatically by a control signal.

FIG. 5 illustrates an example computing system 500 for UPI data transmission using a communication cable 530 with an integrated driver 532. The computing system 500 can be the computing system 100 of FIG. 1. The communication cable 530 can be same as, or similar to, the communication cable 130 of FIG. 1, or 200 of FIG. 2A-2B. The driver 532 can be same as, or similar to, the driver 132 of FIG. 1, or 210 of FIGS. 2A-2B. The communication cable 530 can be configured to transfer a signal according to UPI protocol, and the driver 532 can be configured to drive the signal according to the UPI protocol. The driver 532 can be a UPI driver. The driver 532 can include a driver circuit board (e.g., the driver circuit board 212 of FIG. 2) and one or more driver circuits (e.g., the TX driver circuit 220 and/or the RX driver circuit 230 of FIG. 2). The communication cable 530 can enable high speed UPI data transmission with high signal quality and strength.

The computing system 500 includes a first assembly 510 (e.g., the first assembly 110 of FIG. 1) and a second assembly 520 (e.g., the second assembly 120 of FIG. 1) that are connected by the communication cable 530. Each of the first assembly 510 and the second assembly 520 can be a PCBA assembly.

As illustrated in FIG. 5, the first assembly 510 includes a first circuit board 512 (e.g., the first circuit board 112 of FIG. 1), a first processing device 511, and a first platform controller 514. The first processing device 511 and the first platform controller 514 are integrated on the first circuit board 512 and can communicate, e.g., via Direct Media Interface (DMI). The first assembly 510 can further include a first connector 518 (e.g., the first connector 118 of FIG. 1, the 318 of FIG. 3, or 418 of FIG. 4) integrated on the first circuit board 512 and coupled to the platform controller 514.

Similar to the first assembly 510, the second assembly 520 includes a second circuit board 522 (e.g., the second circuit board 522 of FIG. 1), a second processing device 521, and a second platform controller 524. The second processing device 521 and the second platform controller 524 are integrated on the second circuit board 522 and can communicate, e.g., via Direct Media Interface (DMI). The second assembly 520 can further include a second connector 528 (e.g., the second connector 128 of FIG. 1, the 328 of FIG. 3, or 428 of FIG. 4) integrated on the second circuit board 522 and coupled to the platform controller 524.

The communication cable 530 includes a first interface 534 (e.g., the first interface 202 of FIG. 2A), a second interface 536 (e.g., the second interface 204 of FIG. 2A), and electrical wires 531 (e.g., the electrical wires 206 of FIG. 2A) that are coupled between the first interface 534 and the second interface 536. The communication cable 530 is coupled to the first connector 518, e.g., by connecting the first interface 534 with the first connector 518, and is coupled to the second connector 528, e.g., by connecting the second interface 536 with the second connector 528. In some examples, the first connector 518 or the second connector 528 includes a SLIMline connector such as a SlimSAS 8i connector. The first connector 518 or the second connector 528 can use an Integrated Drive Electronics (IDE) interface.

In some implementations, the first processing device 511 or the second processing device 521 includes, e.g., a central processing unit (CPU), a graphics processing unit (GPU), a multi-core Processor, a data processing unit (DPU), a tensor processing unit (TPU), a quantum processing unit (QPU), an Application Specific Integrated Circuit (ASIC), a Field Programmable Gate Array (FPGA), a microprocessor, or any other processing device, or a combination thereof. The first circuit board 512 or the second circuit board 522 can be a processing circuit board or a motherboard. In some implementations, the first platform controller 514 or the second platform controller 524 can be, e.g., a Platform Controller Hub (PCH). The platform controller 514, 524 can control data paths and support functions used in conjunction with the processing device 511, 521. In some implementations, the platform controller 514, 524 includes clocking (the system clock), Flexible Display Interface (FDI), and/or Direct Media Interface (DMI).

As illustrated in FIG. 5, the first processing device 511 can be same as, or similar to, the first device 114 of FIG. 1, and the second processing device 521 can be same as, or similar to, the second device 124 of FIG. 1. The first processing device 511 and the second processing device 512 can use a UPI protocol to connect the first processing device 511 on the first circuit board 512 with the second processing device 521 on the second circuit board 522.

In some implementations, as illustrated in FIG. 5, the first processing device 511 includes a first UPI controller 516 (e.g., the first controller 116 of FIG. 1) that can include multiple pairs (e.g., 4 pairs) of UPI transmitter (TX) 513a and PCIe receiver (RX) 513b. Each of the UPI TXs 513a and the UPI RXs 513b can be associated with a signal path. Similarly, the second processing device 521 includes a second UPI controller 526 (e.g., the second controller 126 of FIG. 1) that can include multiple pairs (e.g., 4 pairs) of UPI receiver (RX) 523a and UPI transmitter (TX) 523b. Each of the UPI TXs 523a and the UPI RXs 523b can be associated with a signal path.

Along a TX signal path, a UPI TX 513a in the first UPI controller 516 is configured to transmit a signal from the first processing device 511 through the first connector 518, the communication cable 530, and the second connector 528 to a corresponding UPI RX 523a in the second UPI controller 526. The signal can be driven (or amplified) by a TX driver circuit in the driver 532, e.g., the TX driver circuit 220 of FIG. 2B.

Similarly, along a RX signal path, a UPI RX 513b in the first UPI controller 516 is configured to receive a signal from a corresponding UPI TX 523b in the second UPI controller 526 through the second connector 528, the communication cable 530, and the first connector 518, to the UPI RX 513b in the first UPI controller 516. The signal can be driven (or amplified) by a RX driver circuit in the driver 532, e.g., the RX driver circuit 230 of FIG. 2B.

In some implementations, the driver circuit (e.g., the TX or RX driver circuit) in the driver 532 includes a linear driver (e.g., the linear driver 222 of FIG. 2B) and a control circuit (e.g., the control circuit 224 of FIG. 2B) coupled to the linear driver. The linear driver can be an operational amplifier (OPA). The control circuit can be a digital circuit, e.g., a complex programmable logic device (CPLD). In some implementations, the processing device 511 in the first assembly 510 includes a I2C master 515 (e.g., a microcontroller). The I2C master 515 in the processing device 511 can be coupled to the control circuit in the driver 532 through the first connector 518, the interface (e.g., the first interface 534) of the communication cable 530, and a corresponding connection pin (e.g., the connection pin 215 of FIG. 2) on the driver circuit board of the driver 532.

The control circuit can be configured to receive an I2C command (e.g., from the I2C master 515) to control the linear driver to drive the received signal based on the I2C command. The I2C master 515 is configured to generate the I2C command based on a feedback signal from the communication cable 530, such that the driver circuit (e.g., RX or TX) can be dynamically adjusted based on a requirement or need of the system. For example, the driver circuit can amplify the signal, and the amplification factor may be not a fixed value, which may be determined by the situation through the I2C feedback of the driver circuit, and then the I2C master 515 can adjust the amplification factor of the driver circuit.

In some implementations, the driver circuit (e.g., the TX or RX driver circuit) includes a resistor (e.g., the resistor 236 of FIG. 2B) coupled to the linear driver. The resistor can be coupled to the ground (e.g., by the power pin 213c of FIG. 2B). The resistor can be adjustable to change a resistance of the resistor to control the linear driver to drive the received signal. The resistor can be adjusted manually or automatically by a control signal.

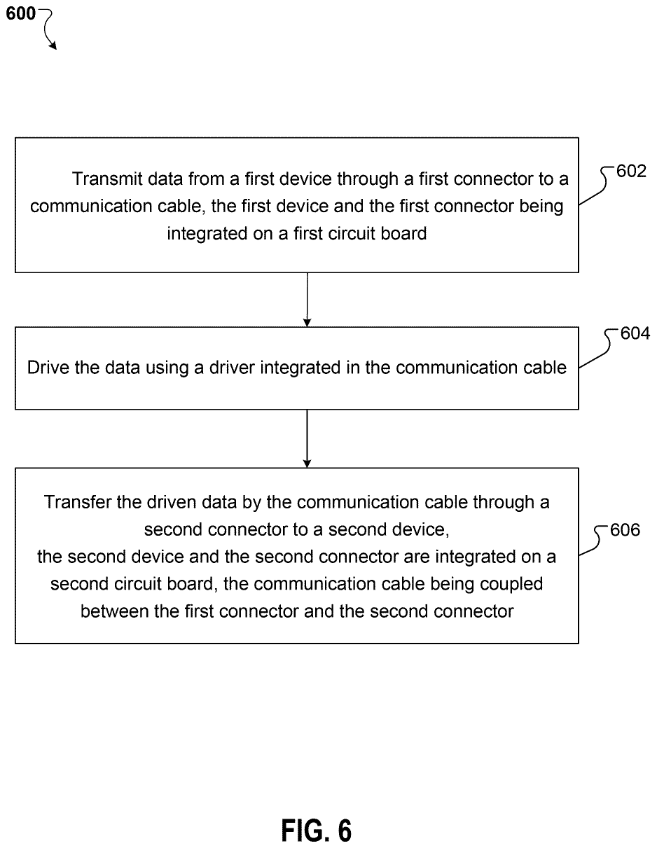

FIG. 6 is a flowchart of an example process 600 of a method for managing signal transmissions using a communication cable with an integrated driver. For clarity of presentation, the description that follows generally describes method in the context of the other figures in this description. However, it will be understood that the process 600 can be performed, for example, by any system, environment, software, and hardware, or a combination of systems, environments, software, and hardware, as appropriate. In some implementations, various steps of the process 600 can be run in parallel, in combination, in loops, or in any order. In some implementations, a computing system can perform one or more, or all of the steps described in the process 600. The computing system can be same as, or similar to, the computing system 100 of FIGS. 1, 300 of FIGS. 3, 400 of FIG. 4, or 500 of FIG. 5. The communication cable can be same as, or similar to, the communication cable 130 of FIGS. 1, 200 of FIGS. 2A, 330 of FIGS. 3, 430 of FIG. 4, or 530 of FIG. 5. The integrated driver can be same as, or similar to, the driver 132 of FIGS. 1, 210 of FIGS. 2A-2B, 332 of FIGS. 3, 432 of FIG. 4, or 532 of FIG. 5.

At 602, a signal is transmitted from a first device through a first connector to the communication cable. The first device and the first connector are integrated on a first circuit board. The first device can be, e.g., the first device 114 of FIG. 1, the platform controller 314 of FIG. 3, the processing device 411 of FIG. 4, or the first processing device 511 of FIG. 5. The first circuit board can be, e.g., the first circuit board 112 of FIGS. 1, 312 of FIGS. 3, 412 of FIG. 4, or 512 of FIG. 5. The first connector can be, e.g., the first connector 118 of FIGS. 1, 318 of FIGS. 3, 418 of FIG. 4, or 518 of FIG. 5. In some implementations, a size of the driver circuit board is smaller than a size (e.g., a diamaeter) of the communication cable. The driver can further include a protection layer covering the driver circuit board and the at least one driver circuit, the protection layer being made of an electrically insulated material.

At 604, the signal is driven using a driver integrated in the communication cable. In some implementations, each of the at least one driver circuit includes: a linear driver coupled in each of the plurality of signal paths between the corresponding first connection pin and the corresponding second connection pin and configured to amplify a received signal and output an amplified signal. The linear driver can be, e.g., the linear driver 222 or 232 of FIG. 2B, or the linear driver as described with respect to FIGS. 3, 4, or 5.

The driver can be configured to: in response to a power of the signal being smaller than a threshold, amplify the signal to be above the threshold. In some implementations, each of the at least one driver circuit further includes: a control circuit coupled to the linear driver and configured to receive an I2C (inter-integrated circuit) command to control the linear driver to amplify the received signal based on the I2C command. The control circuit can be, e.g., the control circuit 224 or 234 of FIG. 2B, or the control circuit as described with respect to FIGS. 3, 4, or 5.

In some implementations, at least one of the first device or the second device can include an I2C master (e.g., the I2C master 315 of FIGS. 3, 415 of FIG. 4, or 515 of FIG. 5) configured to transmit the I2C command to the control circuit through a corresponding one of the first connector and the second connector, a corresponding electrical wire in the communication cable, and a corresponding connection pin on the driver circuit board. The I2C master can be configured to generate the I2C command based on a feedback from a power of the amplified signal, and the control circuit can be configured to control the linear driver to adjust an amplification factor of the signal based on the I2C command. In some implementations, the I2C master includes a microcontroller unit (MCU), and the control circuit includes a complex programmable logic device (CPLD).

In some implementations, each of the at least one driver circuit further includes a resistor (e.g., the resistor 226 of FIG. 2B) coupled between the linear driver and a ground. The resistor is configured to be adjustable to change a resistance of the resistor to control the linear driver to amplify the received signal.

At 606, the driven signal is transferred by the communication cable through a second connector to a second device. The second device and the second connector are integrated on a second circuit board. The communication cable is coupled between the first connector on the first circuit board and the second connector on the second circuit board. The second device can be, e.g., the second device 124 of FIG. 1, the device connectors 324 of FIG. 3, the device connectors 424 of FIG. 4, or the second processing device 521 of FIG. 5. The second circuit board can be, e.g., the second circuit board 122 of FIGS. 1, 322 of FIGS. 3, 422 of FIG. 4, or 522 of FIG. 5. The second connector can be, e.g., the second connector 128 of FIGS. 1, 328 of FIGS. 3, 428 of FIG. 4, or 528 of FIG. 5.

In some implementations, the driver includes a driver circuit board and at least one driver circuit integrated on the driver circuit board. The at least one driver circuit is configured to drive the signal. The driver circuit board can be, e.g., the driver circuit board 212 of FIG. 2B or the driver circuit board as described with respect to FIGS. 3, 4, or 5. The at least one driver circuit can be, e.g., the TX driver circuit 220 and/or the RX driver circuit 230 of FIG. 2B, or the one or more driver circuits as described with respect to FIGS. 3, 4, or 5.

In some implementations, the communication cable includes a plurality of first electrical wires coupled to the first connector and a plurality of second electrical wires coupled to the second connector. The driver circuit board can include one or more first connection pins (e.g., 213a, 213b, 213c, 214a, 214d, 215 of FIG. 2B) coupled to one or more first electrical wires and one or more second connection pins (e.g., 214b, 214c of FIG. 2B) coupled to one or more second electrical wires. The one or more first connection pins and the one or more second connection pins being on a peripheral area of the driver circuit board. Each of the at least one driver circuit can include one or more first nodes coupled to the one or more first connection pins and one or more second nodes coupled to the one or more second connection pins.

In some implementations, the communication cable is configured to transfer the signal between the first device and the second device through a plurality of signal paths. Each of the plurality of signal paths can be associated with a corresponding first electrical wire, a corresponding first connection pin, a corresponding first node, a corresponding second node, a corresponding second connection pin, and a corresponding second electrical wire.

In some implementations, along each of the plurality of signal paths, the driver further includes at least one of: a first capacitor (e.g., the capacitor 216a or 216d of FIG. 2B) coupled between a first connection pin and a corresponding first node, or a second capacitor (e.g., the capacitor 216b or 216c of FIG. 2B) coupled between a second connection pin and a corresponding second node.

In some implementations, the at least one driver circuit includes at least one of a transmitter (TX) driver circuit (e.g., the TX driver circuit 220 of FIG. 2B) or a receiver (RX) driver circuit (e.g., the RX driver circuit 230 of FIG. 2B). The transmitter driver circuit is configured to drive a first signal transmitted from the first device to the second device, and the receiver driver circuit is configured to drive a second signal transmitted from the second device to the first device.

In some implementations, the plurality of signal paths include multiple pairs of a transmitter signal path and a receiver signal path, each pair of the transmitter signal path and the receiver signal path being associated with a respective first component in the first device and a respective second component in the second device, and transmitter signal paths of the plurality of signal paths are associated with the transmitter driver circuit, and receiver signal paths of the plurality of signal paths are associated with the receiver driver circuit. A number of the transmitter signal paths can be identical to a number of the receiver signal paths.

In some implementations, e.g., as illustrated in FIG. 3, the signal is transferred according to Serial Advanced Technology Attachment (SATA) protocol, and the respective first component includes an SATA transmitter (e.g., SATA TX 313a of FIG. 3) for the transmitter signal path and an SATA receiver (e.g., SATA RX 313b of FIG. 3) for the receiver signal path, and the driver is configured to drive the signal according to the SATA protocol. The respective second component includes a device connector (e.g., the device controller 324 of FIG. 3) coupled to a storage device (e.g., the storage device 340 of FIG. 3) for receiving or transmitting the signal. The first device can include a platform controller (e.g., the platform controller 314 of FIG. 3) configured to control communication between a processing device (e.g., the processing device 311 of FIG. 3) integrated in the first circuit board and one or more storage devices (e.g., the storage devices 340 of FIG. 3) coupled to the second device.

In some implementations, e.g., as illustrated in FIG. 4, the signal is transferred according to a Peripheral Component Interconnect Express (PCIe) protocol. The respective first component includes a PCIe transmitter (e.g., the PCIe TX 414a of FIG. 4) for the transmitter signal path and a PCIe receiver (e.g., the PCIe RX 414b of FIG. 4) for the receiver signal path. The driver is configured to drive the signal according to the PCIe protocol. The respective second component includes a device connector (e.g., the device connector 424 of FIG. 4) coupled to a PCIe device (e.g., the PCIe device 440 of FIG. 4) for receiving or transmitting the signal. The first device includes a processing device (e.g., the processing device 414 of FIG. 4) configured to communicate with the PCIe device. In some examples, the PCIe device includes a Non-Volatile Memory Express (NVMe) storage device, and the processing device is connected to the storage device according to an NVMe protocol.

In some implementations, e.g., as illustrated in FIG. 5, the signal is transferred according to an ultra path interconnect (UPI) protocol, and the driver is configured to drive the signal according to the UPI protocol. The first device includes a first processing device (e.g., the first processing device 511 of FIG. 5), and the second device includes a second processing device (e.g., the second processing device 521 of FIG. 5). The respective first component includes a first UPI transmitter (e.g., the UPI TX 513a of FIG. 5) for the transmitter signal path and a first UPI receiver (e.g., the UPI RX 513b of FIG. 5) for the receiver signal path, and the respective second component includes a second UPI receiver (e.g., the UPI RX 523a of FIG. 5) coupled to the first UPI transmitter through the transmitter signal path and a second UPI transmitter (e.g., the UPI TX 523b of FIG. 5) coupled to the first UPI receiver through the receiver signal path. The first device is coupled to a first platform controller (e.g., the first platform controller 514 of FIG. 5) integrated on the first circuit board, and the second device is coupled to a second platform controller (e.g., the second platform controller 524 of FIG. 5) integrated on the second circuit board.

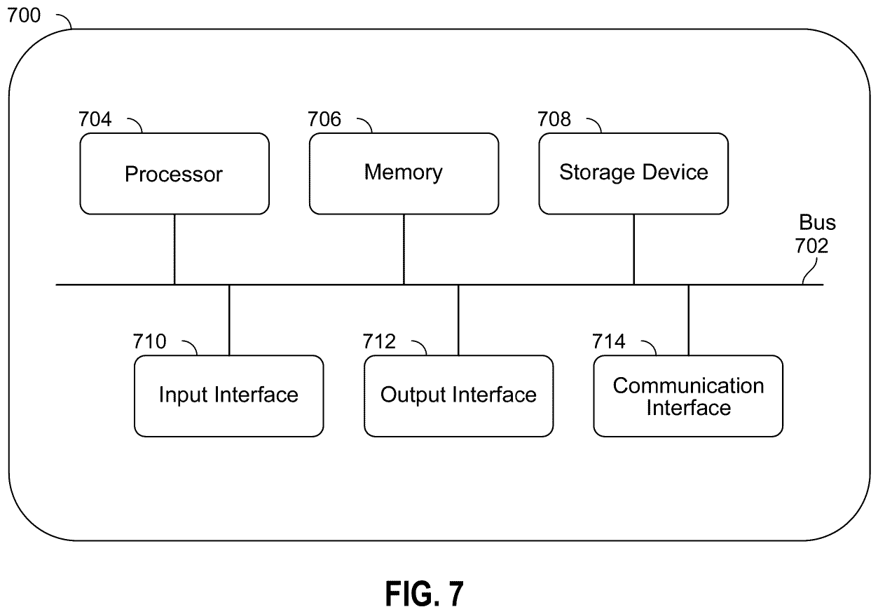

FIG. 7 is a block diagram illustrating an example architecture of a computing device 700 used to provide computational functionalities associated with described algorithms, methods, functions, processes, flows, and procedures. Other architectures are possible, including architectures with more or fewer components. The computing device 700 includes processor 704, memory 706, storage component 708, input interface 710, output interface 712, communication interface 714, and bus 702.

Communication cables implemented in the present disclosure (e.g., the communication cable 130 of FIGS. 1, 330 of FIGS. 3, 430 of FIG. 4, or 530 of FIG. 5) can be applied in the computing device 700. For example, a communication cable with an integrated driver (e.g., the driver 132 of FIGS. 1, 200 of FIGS. 2, 332 of FIGS. 3, 432 of FIG. 4, or 532 of FIG. 5) can be coupled between the processor 704 and the memory 706 and/or the storage component 708 and configured to transfer data between the processor 704 and the memory 706 and/or the storage component 708 (e.g., according to SATA protocol or PCIe protocol), and the integrated driver can be configured to drive the data transferred by the communication cable.

Bus 702 includes a component that permits communication among the components of the computing device 700. In some embodiments, processor 704 is implemented in hardware, software, or a combination of hardware and software. In some examples, processor 704 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 706 includes random access memory (RAM), read-only memory (ROM), and/or another type of dynamic and/or static storage device (e.g., flash memory, magnetic memory, optical memory, and/or the like) that stores data and/or instructions for use by processor 704.

Storage component 708 stores data and/or software related to the operation and use of the computing device 700. In some examples, storage component 708 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 710 includes a component that permits the computing device 700 to receive information, such as via user input (e.g., a touchscreen display, a keyboard, a keypad, a mouse, a button, a switch, a microphone, a camera, and/or the like). Additionally or alternatively, in some embodiments input interface 710 includes a sensor that senses information (e.g., a global positioning system (GPS) receiver, an accelerometer, a gyroscope, an actuator, and/or the like). Output interface 712 includes a component that provides output information from the computing device 700 (e.g., a display, a speaker, one or more light-emitting diodes (LEDs), and/or the like).

In some embodiments, communication interface 714 includes a transceiver-like component (e.g., a transceiver, a separate receiver and transmitter, and/or the like) that permits the computing device 700 to communicate with other devices via a wired connection, a wireless connection, or a combination of wired and wireless connections. In some examples, communication interface 714 permits the computing device 700 to receive information from another device and/or provide information to another device. In some examples, communication interface 714 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, the computing device 700 performs one or more processes described herein. The computing device 700 performs these processes based on processor 704 executing software instructions stored by a computer-readable medium, such as memory 706 and/or storage component 708. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 706 and/or storage component 708 from another computer-readable medium or another device via communication interface 714. When executed, software instructions stored in memory 706 and/or storage component 708 cause processor 704 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 706 and/or storage component 708 includes data storage or at least one data structure (e.g., a database and/or the like). The computing device 700 is capable of receiving information from, storing information in, communicating information to, or searching information stored in the data storage or the at least one data structure in memory 706 or storage component 708. In some examples, the information includes network data, input data, output data, or any combination thereof.

In some embodiments, the computing device 700 is configured to execute software instructions that are either stored in memory 706 and/or in the memory of another device (e.g., another device that is the same as or similar to the computing device 700). As used herein, the term “module” refers to at least one instruction stored in memory 706 and/or in the memory of another device that, when executed by processor 704 and/or by a processor of another device (e.g., another device that is the same as or similar to the computing device 700) cause the computing device 700 (e.g., at least one component of the computing device 700) to perform one or more processes described herein. In some embodiments, a module is implemented in software, firmware, hardware, and/or the like.

The number and arrangement of components illustrated in FIG. 7 are provided as an example. In some embodiments, the computing device 700 can include additional components, fewer components, different components, or differently arranged components than those illustrated in FIG. 7. Additionally or alternatively, a set of components (e.g., one or more components) of the computing device 700 can perform one or more functions described as being performed by another component or another set of components of the computing device 700.

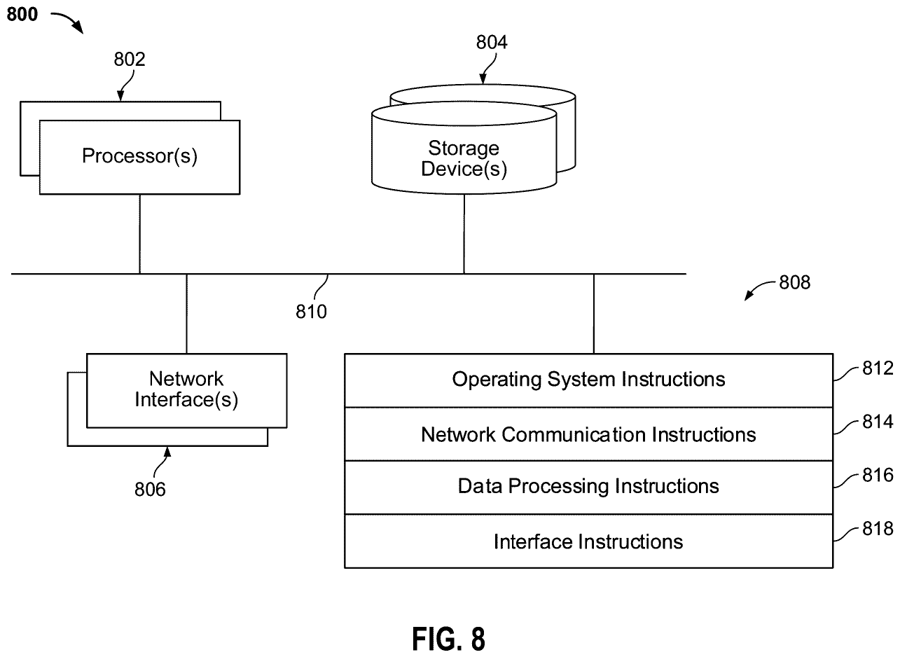

FIG. 8 illustrates an example architecture 800 of a computing system used to provide computational functionalities associated with described algorithms, methods, functions, processes, flows, and procedures. The computing system can be implemented as the computing system 100 of FIGS. 1, 300 of FIGS. 3, 400 of FIG. 4, or 500 of FIG. 5. Other architectures are possible, including architectures with more or fewer components.

In some implementations, architecture 800 includes one or more processor(s) 802 (e.g., dual-core Intel® Xeon® Processors), one or more network interface(s) 806, one or more storage device(s) 804 (e.g., hard disk, optical disk, flash memory) and one or more computer-readable medium(s) 808 (e.g., hard disk, optical disk, flash memory, etc.). These components can exchange communications and data over one or more communication channel(s) 810 (e.g., buses), which can utilize various hardware and software for facilitating the transfer of data and control signals between components.

Communication cables implemented in the present disclosure (e.g., the communication cable 130 of FIGS. 1, 330 of FIGS. 3, 430 of FIG. 4, or 530 of FIG. 5) can be applied in the computing system. For example, the one or more processors 802 can be integrated in a processing circuit board, and the one or more storage devices 804 can be integrated in a storage circuit board, and a communication cable with an integrated driver (e.g., the driver 132 of FIGS. 1, 200 of FIGS. 2, 332 of FIGS. 3, 432 of FIG. 4, or 532 of FIG. 5) can be coupled between the processing circuit board and the storage circuit board and configured to transfer data between the one or more processors 802 and the one or more storage devices 804 (e.g., according to SATA protocol or PCIe protocol), and the integrated driver can be configured to drive the data transferred by the communication cable. In some implementations, a communication cable with an integrated driver is configured to transfer data between two processors 802 (e.g., according to UPI protocol).

The term “computer-readable medium” refers to any medium that participates in providing instructions to the processor(s) 802 for execution, including without limitation, non-volatile media (e.g., optical or magnetic disks), volatile media (e.g., memory) and transmission media. Transmission media includes, without limitation, coaxial cables, copper wire, and fiber optics.

Computer-readable medium(s) 808 can further include instructions 812 for an operating system (e.g., Mac OS® server, Windows® NT server, Linux Server), instructions 814 for network communications module, data processing instructions 816, and interface instructions 818.

Operating systems can be multi-user, multiprocessing, multitasking, multithreading, real time, etc. Operating system performs basic tasks, including but not limited to: recognizing input from and providing output to devices 802, 804, 806 and 808; keeping track and managing files and directories on computer-readable medium(s) 808 (e.g., memory or a storage device); controlling peripheral devices; and managing traffic on the one or more communication channel(s) 810. Network communications module includes various components for establishing and maintaining network connections (e.g., software for implementing communication protocols, such as TCP/IP, HTTP, etc.) and for creating a distributed streaming platform using, for example, Apache Kafka™. Data processing instructions 816 include server-side or backend software for implementing the server-side operations. Interface instructions 818 includes software for implementing a web server and/or portal for sending and receiving data to and from user side computing devices and service side computing devices.

Architecture 800 can be implemented by a cloud computing system and can be included in any computer device, including one or more server computers in a local or distributed network each having one or more processing cores. Architecture 800 can be implemented in a parallel processing or peer-to-peer infrastructure or on a single device with one or more processors. Software can include multiple software components or can be a single body of code.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

What is claimed is:

1. A computing system, comprising:
a first device integrated on a first circuit board;
a first connector integrated on the first circuit board and coupled to the first device;
a second device integrated on a second circuit board;
a second connector integrated on the second circuit board and coupled to the second device; and
a communication cable coupled between the first connector and the second connector and configured to transfer a signal between the first device and the second device,
wherein the communication cable comprises a driver integrated in the communication cable and configured to drive the signal transferred by the communication cable between the first device and the second device.

2. The computing system of claim 1, wherein the driver comprises:
a driver circuit board; and
at least one driver circuit integrated on the driver circuit board, wherein the at least one driver circuit is configured to drive the signal.

3. The computing system of claim 2, wherein the communication cable comprises a plurality of first electrical wires coupled to the first connector and a plurality of second electrical wires coupled to the second connector,
wherein the driver circuit board comprises one or more first connection pins coupled to one or more first electrical wires and one or more second connection pins coupled to one or more second electrical wires, the one or more first connection pins and the one or more second connection pins being on a peripheral area of the driver circuit board, and
wherein each of the at least one driver circuit comprises one or more first nodes coupled to the one or more first connection pins and one or more second nodes coupled to the one or more second connection pins.

4. The computing system of claim 3, wherein the communication cable is configured to transfer the signal between the first device and the second device through a plurality of signal paths, and
wherein each of the plurality of signal paths is associated with a corresponding first electrical wire, a corresponding first connection pin, a corresponding first node, a corresponding second node, a corresponding second connection pin, and a corresponding second electrical wire.

5. The computing system of claim 4, wherein the at least one driver circuit comprises at least one of a transmitter (TX) driver circuit or a receiver (RX) driver circuit, and
wherein the transmitter driver circuit is configured to drive a first signal transmitted from the first device to the second device, and the receiver driver circuit is configured to drive a second signal transmitted from the second device to the first device.

6. The computing system of claim 5, wherein the plurality of signal paths comprise multiple pairs of a transmitter signal path and a receiver signal path, each pair of the transmitter signal path and the receiver signal path being associated with a respective first component in the first device and a respective second component in the second device, and
wherein transmitter signal paths of the plurality of signal paths are associated with the transmitter driver circuit, and receiver signal paths of the plurality of signal paths are associated with the receiver driver circuit.

7. The computing system of claim 6, wherein the signal is transferred according to Serial Advanced Technology Attachment (SATA) protocol, and the respective first component comprises an SATA transmitter for the transmitter signal path and an SATA receiver for the receiver signal path, and the driver is configured to drive the signal according to the SATA protocol,
wherein the respective second component comprises a device connector coupled to a storage device for receiving or transmitting the signal, and
wherein the first device comprises a platform controller configured to control communication between a processing device integrated in the first circuit board and one or more storage devices coupled to the second device.

8. The computing system of claim 6, wherein the signal is transferred according to a Peripheral Component Interconnect Express (PCIe) protocol, and the respective first component comprises a PCIe transmitter for the transmitter signal path and a PCIe receiver for the receiver signal path, and the driver is configured to drive the signal according to the PCIe protocol,
wherein the respective second component comprises a device connector coupled to a PCIe device for receiving or transmitting the signal, and
wherein the first device comprises a processing device configured to communicate with the PCIe device.

9. The computing system of claim 6, wherein the signal is transferred according to an ultra path interconnect (UPI) protocol, and the driver is configured to drive the signal according to the UPI protocol,
wherein the first device comprises a first processing device, and the second device comprises a second processing device, and
wherein the respective first component comprises a first UPI transmitter for the transmitter signal path and a first UPI receiver for the receiver signal path, and wherein the respective second component comprises a second UPI receiver coupled to the first UPI transmitter through the transmitter signal path and a second UPI transmitter coupled to the first UPI receiver through the receiver signal path.

10. The computing system of claim 4, wherein each of the at least one driver circuit comprises:
a linear driver coupled in each of the plurality of signal paths between the corresponding first connection pin and the corresponding second connection pin and configured to amplify a received signal and output an amplified signal.

11. The computing system of claim 10, wherein each of the at least one driver circuit further comprises:
a control circuit coupled to the linear driver and configured to receive an I2C (inter-integrated circuit) command to control the linear driver to amplify the received signal based on the I2C command,
wherein at least one of the first device or the second device comprises an I2C master configured to transmit the I2C command to the control circuit through a corresponding one of the first connector and the second connector, a corresponding electrical wire in the communication cable, and a corresponding connection pin on the driver circuit board.

12. A communication cable, comprising:
a plurality of first electrical wires;
a plurality of second electrical wires; and
a driver coupled between the plurality of first electrical wires and the plurality of second electrical wires,
wherein the driver comprises a driver circuit board and at least one driver circuit integrated on the driver circuit board,
wherein the driver circuit board comprises:
one or more first connection pins coupled to one or more first electrical wires of the plurality of first electrical wires, and
one or more second connection pins coupled to one or more second electrical wires of the plurality of second electrical wires, and
wherein the at least one driver circuit is configured to driver a signal transferred by the one or more first electrical wires and the one or more second electrical wires.

13. The communication cable of claim 12, wherein the one or more first connection pins and the one or more second connection pins are on a peripheral area of the driver circuit board, and
wherein each of the at least one driver circuit comprises one or more first nodes coupled to the one or more first connection pins and one or more second nodes coupled to the one or more second connection pins.

14. The communication cable of claim 13, wherein the communication cable is configured to transfer the signal through a plurality of signal paths, and
wherein each of the plurality of signal paths is associated with a corresponding first electrical wire, a corresponding first connection pin, a corresponding first node, a corresponding second node, a corresponding second connection pin, and a corresponding second electrical wire.

15. The communication cable of claim 14, wherein, along each of the plurality of signal paths, the driver further comprises at least one of:
a first capacitor coupled between a first connection pin and a corresponding first node, or
a second capacitor coupled between a second connection pin and a corresponding second node.

16. The communication cable of claim 14, wherein the at least one driver circuit comprises at least one of a transmitter (TX) driver circuit or a receiver (RX) driver circuit, and
wherein the transmitter driver circuit is configured to drive a first signal transmitted from the one or more first electrical wires to the one or more second electrical wires, and the receiver driver circuit is configured to drive a second signal transmitted from the one or more second electrical wires to the one or more first electrical wires,
wherein the plurality of signal paths comprise multiple pairs of a transmitter signal path and a receiver signal path,
wherein transmitter signal paths of the plurality of signal paths are associated with the transmitter driver circuit, and receiver signal paths of the plurality of signal paths are associated with the receiver driver circuit, and
wherein a number of the transmitter signal paths is identical to a number of the receiver signal paths.

17. The communication cable of claim 14, wherein each of the at least one driver circuit comprises:
a linear driver coupled in each of corresponding signal paths between the corresponding first connection pin and the corresponding second connection pin and configured to drive a received signal and output a driven signal, and
a control circuit coupled to the linear driver and configured to receive an I2C (inter-integrated circuit) command to control the linear driver to drive the received signal based on the I2C command.

18. The communication cable of claim 12, wherein the at least one driver circuit is configured to driver the signal according to a protocol, and
wherein the protocol comprises a Serial Advanced Technology Attachment (SATA) protocol, a Peripheral Component Interconnect Express (PCIe) protocol, or an ultra path interconnect (UPI) protocol.

19. The communication cable of claim 12, wherein the driver further comprises a protection layer enclosing the driver circuit board and the at least one driver circuit, the protection layer being made of an electrically insulated material.

20. A method, comprising:
transmitting a signal from a first device through a first connector to a communication cable, wherein the first device and the first connector are integrated on a first circuit board;
driving the signal using a driver integrated in the communication cable; and
transmitting the driven signal by the communication cable through a second connector to a second device, wherein the second device and the second connector are integrated on a second circuit board,
wherein the communication cable is coupled between the first connector on the first circuit board and the second connector on the second circuit board.
